(19) United States
(12) Patent Application Publication
(10) Pub. No.: US 2004/0078931 A1
(43) Pub. Date: Apr. 29, 2004

(54) Door jig assembly for use during manufacture of a vehicle

(76) Inventor: Jeffrey C. Krozek, Harrison Township, MI (US)

Correspondence Address: GIFFORD, KRASS, GROH, SPRINKLE, ANDERSON & CITKOWSKI, PC, 280 N OLD WOODARD AVE, SUITE 400, BIRMINGHAM, MI, 48009, US

(21) Appl. No.: 10/691,088

(22) Filed: Oct. 22, 2003

Related U.S. Application Data
(63) Continuation-in-part of application No. 10/261,339, filed on Sep. 30, 2002.

(51) Int. Cl. E05F 1/08; E05F 1/14

(52) U.S. Cl. 16/303; 16/280

(57) ABSTRACT

A door jig assembly for a vehicle, the vehicle having a door and an inner door jamb forming a part of a vehicle door frame. An arcuate bracket portion is fixedly secured to the inner door jamb. A coil spring member surrounds an intermediate extending location of the bracket portion, a first tab end of the coil spring biasingly engaging a location along the bracket portion and a second extending stem and passing through an aperture defined in the vehicle door. A collar secures to a further location of the bracket portion and exhibits a cam surface in abutting contact with an arcuate extending surface of the coil spring member. The coil spring member influences the door to remain in a first closed position, subsequent rotation of the door causing the spring to rotate about the cam surface to influence the door in an opposite and door open position.

### CROSS REFERENCE TO RELATED APPLICATION

The present application is a continuation-in-part of U.S. application Ser. No. 10/261,339 filed Sep. 30, 2002 for a Door Jig Assembly for Use During Manufacture of a Vehicle.

### BACKGROUND OF THE INVENTION

1. Field of the Invention

The present invention relates generally to door opening and closure assemblies, such as those which are particularly employed in vehicles. More specifically, the present invention discloses a door detent, or jig, assembly which is temporarily installed upon a vehicle during its manufacturing, and which functions to establish a selected holding force in either or both a closed or opened position of the hingedly attached door relative to the vehicle pillar. The jig assembly further maintains the door in a desired open or closed position during the various manufacturing steps performed in the vehicle as it is translated along the vehicle assembly line, and in spite of any accidental or unanticipated contact forces occurring during such assembly.

2. Description of the Prior Art

The prior art is well documented with examples of door checking and door closure mechanisms, most particularly those employed in vehicle doors. Such door checking mechanisms are typically installed in the completed vehicle, forming a permanent part thereof, and a first example of this is set forth in U.S. Pat. No. 5,173,991, issued to Carswell which teaches such a component which forms a permanent part of the vehicle door structure. In particular, the closure mechanism is moveable in relation to the frame and includes a housing affixed to the closure member or the frame and having an opening defined therethrough.

A link member in Carswell is fastened either to the frame or the closure member and is moveable in relation to the housing by passing through the opening. Link engaging means secure with the housing proximate the opening proximate at least one side of the link member and include at least one compatible groove formed proximate at least one side of the link member for positioning the link member in relation to the housing, the grooves of the link member being formed by coating the core thereof with a moldable material prior to assembly of the checking mechanism.

An additional example of a door check assembly is disclosed in Koch, U.S. Pat. No. 6,178,594, and which teaches an elongated body having side walls defining a channel and an energy absorber. When mounted to a door, a pivot pin is inserted through an opening at the first end of the elongated body and a slide pin extends through the channel. The pivot pin is attached to the door and the slide pin attached to structure (pillar) adjacent the door. As the door is opened, the elongated body moves relative to the slide pin to position the slide pin toward the second end portion of the elongated body. The slide pin may be positioned in any one of one or more stop positions which yieldably hold the slide pin. If the door is opened beyond its normal opening arc, the energy absorber is engaged and resists further movement of the door.

An older design of a stay mechanism, similar to Kochs, is disclosed in U.S. Pat. No. 3,392,997, issued to Seckerson et al., and teaches an elongated strap with resilient limbs joined at one end by a substantially flat plate and at the other end by a substantially flat web. In the preferred application, Seckerson teaches a stay arm for holding the bonnet of a rear-engined vehicle in the open position.

U.S. Pat. No. 4,380,848, issued to Guionie, teaches a stop device for a pivotal door which teaches a fixed roller mounted in a bracket member fixed to the fixed post of the door. The arm is applied against the roller and, under the effect of a movable roller mounted on the bracket member, is biased into contact with the arm by a torsion spring which has two windings which are disposed symmetrically on each side of branches of the bracket member.

### SUMMARY OF THE PRESENT INVENTION

As described previously, the present invention discloses a door detent, or jig, assembly which is temporarily installed upon a vehicle during its manufacturing, such as prior to the installation of a door checking mechanism as disclosed in the prior art, and which functions to establish a selected holding force in either or both a closed or opened position of the hingedly attached door relative to the vehicle pillar. As will be further discussed, the jig assembly maintains the door in the desired position, during the various manufacturing steps performed in the vehicle as it is translated along the vehicle assembly line.

As is also known, a vehicle frame is subjected to any of a number of accidental or unanticipated contact forces occurring during assembly, such as further resulting from the successive vehicle frames contacting one another along the assembly line process. The purpose of the jig assembly is to substitute for the door closing and opening holding forces supplied by the handle and door latch assembly, this typically being secured to the door during final assembly of the vehicle. In particular, it is desirous to maintain the door open during such as painting operations, as well as closed during other assembly operations.

The vehicle further includes a door having an inner facing edge, and through which is defined a number of apertures, these typically being associated with the subsequent installation of the door handle hardware. An opposing and inner door jamb forms a part of a vehicle door frame, the door being pivotally secured about hinges to the door frame and between opened and closed positions.

The jig assembly includes an arcuate bracket portion fixedly secured to the inner door jamb. The arcuate bracket portion further comprises first and second legs extending from an intermediate extending location thereof and which engage first and second selected locations along the inner jamb.

A coil spring member encircles (surrounds) the intermediate extending location of the bracket portion. A first curled tab end of the coil spring biasingly engages a location along a lower leg of the bracket portion. A second (upper) end of the coil spring defines an elongate extending stem portion, extending from an upper arcuate extending surface of the coil spring, and which passes through a selected aperture defined in the vehicle door.

A collar is secured to a further location of said bracket portion, proximate an interconnecting location established between the upper end of the coil spring and the intermediate extending location about which is coiled the spring member. The collar exhibits a cam profile, on its lower facing surface, and which is in abutting contact with an upper arcuate extending surface of the coil spring member.

The cam surface further defines a first circumferentially extending and tapered location corresponding with a first door closed position, a succeeding second and circumferentially extending cam lobe location corresponding with a second door open position. The collar is further fixedly secured to the bracket portion by a slot recess defined in a top edge surface and which seats the angled upper leg of the bracket portion. This configuration, combined with the compressing forces applied by the coil spring, prevents the collar from rotating relative the bracket portion.

In application, the upper arcuate surface of the coil spring member seats against the circumferentially extending and tapered location to influence the door to remain in the first closed position. Subsequent rotation of the door to a second open position, typically a 90° rotation, causes the arcuate extending surface of the coil spring to rotate about the fixed lower cam surface of the collar, in seating fashion within the cam lobe location, and to thereby influence the door in an opposite and door open position.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is a perspective view of the door jig assembly according to a preferred embodiment of the present invention and which illustrates a vehicle door in a closed position;

FIG. 2 is an overhead plan view of the door jig assembly as shown in FIG. 1, illustrating both a closed position of the door in solid as well as a succeeding open position in phantom, and further showing the arcuate cantilevering and biasing nature of the extending stem portion extending through the door aperture;

FIG. 3 is a cutaway side profile of the door jig assembly, as substantially illustrated in the closed position of FIG. 1, and which illustrates the spring element in a partially unloaded position relative to the cam collar and which further illustrates in exploded fashion the configuration of the insertable sleeve;

FIG. 4 is a corresponding cutaway side profile of the door jig assembly in a substantially opened position and by which the coil spring element is rotated in a substantially 90° fashion relative the door jamb mounted bracket;

FIG. 5 is an underside perspective view of the cam collar according to the present invention;

FIG. 6 is a side cutaway view of an alternate configuration of a mounting bolt for securing a modified lower end of the arcuate bracket portion in a spatial fashion relative to the inner door jamb surface according to the present invention; and

FIG. 7 is a partially exploded view, in sectional perspective, of the mounting bolt and lower bracket end according to FIG. 6.

### DESCRIPTION OF THE PREFERRED EMBODIMENTS

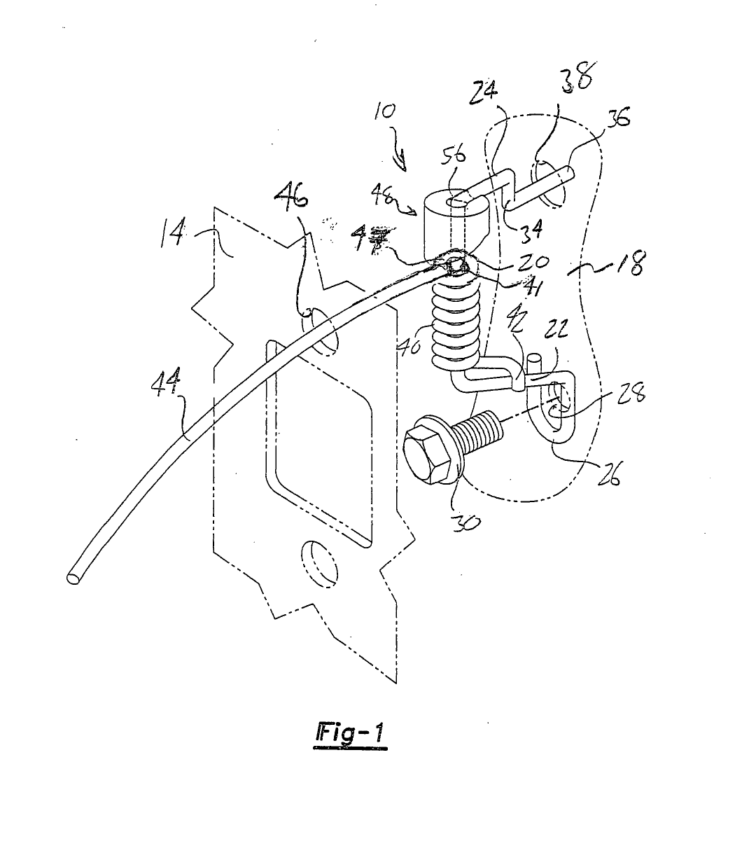

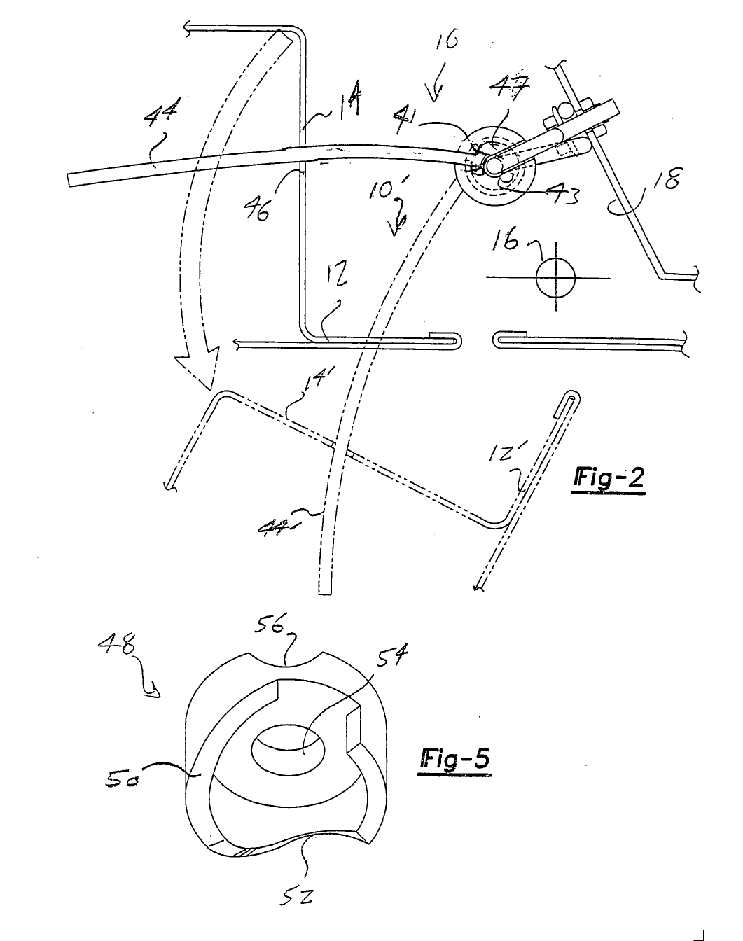

Referring now to FIG. 1, a door jig assembly is generally illustrated at 10 for use with a vehicle. The vehicle, although not shown, includes a door 12 (FIG. 2) having an inner facing edge, see also in phantom at 14 in FIG. 1 as well as in solid in FIG. 2. The door is hingedly connected (see as further designated representatively at 16 in FIG. 2) to an inner door jamb 18, forming a part of a vehicle door frame. Although not clearly illustrated, the door is further capable of being pivoted about the hinges and between opened and closed positions relative to a pillar assembly defining the inner door jamb and frame.

As previously described, the purpose of the jig assembly 10 is to function as an intermediate door holding device (in either opened or closed positions), such as during assembly of a vehicle, and prior to final installation of the door handle and latch elements which form a part of the finished vehicle. It is further desirous to maintain the door open, such as during painting operations, as well as in a closed position at various manufacturing stages.

As illustrated again with reference to FIG. 1, a perspective view of the door jig assembly 10 is shown and which illustrates the vehicle door, see again inner facing edge 14 in phantom, in a substantially closed position. An arcuate bracket portion is provided for being fixedly secured to the inner door jamb 18 and includes an intermediate portion 20, a first lower interconnected and extending leg 22 and a second upper interconnected and extending leg 24.

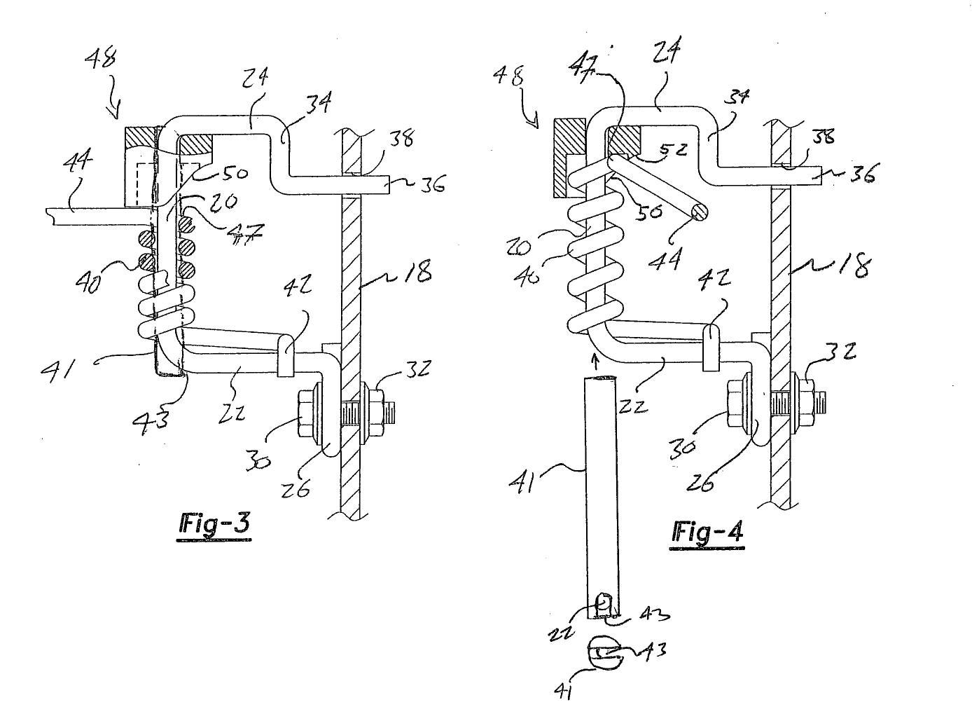

The first or lower leg 22 terminates in a substantially “U” shaped and perpendicularly extending portion 26. The “U” shaped portion 26 is positioned in alignment with an aperture 28 (see inwardly facing wall in FIG. 1) in the door jamb 18 and through which is engaged a mounting bolt 30 (and nut 32 as illustrated in FIGS. 3 and 4) for securing the first leg 22 in place. The upper leg 24 further includes a stepped location 34 and terminates at end 36 which extends through a further aperture 38 (see again in FIG. 1) at a spaced location from aperture 28. In this fashion, the bracket (typically constructed of a durable steel or other suitable material) is secured attached to the door jamb 18 and further so that the intermediate portion 20 extends a spaced distance from the surface of the door jamb.

Referring again to FIG. 1, as well as to FIG. 5, a coil spring member includes a main coiled body 40 which surrounds the intermediate extending location 20 of the bracket portion. The coil spring is constructed of a suitable spring steel material, exhibiting the necessary properties of flexibility and resiliency, and further includes a lower extending and first tab end 42, biasingly engaged against a location of the leg 22 along said bracket portion.

A sleeve 41, see FIGS. 2 and 3, may be inserted between the intermediate portion 20 of the bracket and the surrounding coil 40. The purpose of the sleeve 41, when utilized, is to fill, or take up, the space between the coil windings 40 and the bracket 20 and to thereby maintain the vertical coil centerline in alignment with the bracket 20. The sleeve 41 is further split along its length, see at 43, and in order to facilitate engagement about the stem 20 and it is understood that in certain variants, it can be omitted provided that a correct tolerancing is established between the coil and intermediate bracket.

A second end of the coil spring 40 defines an elongate extending stem portion 44 and which passes through a selected aperture 46 defined in the vehicle door. An arcuate extending surface is identified at 47, and defines a transition between the coil 40 of the spring and the extending cantilever stem 44.

The surface 47 arranges the initiation point of stem 44 at a substantial center of the intermediate bracket 20 as shown. It is further understood that stem 44 forms a perpendicular to intermediate portion 20 of the bracket and thereby permits the spring and stem to cycle evenly through the cam portion of the associated collar and to facilitate opening and closing of the vehicle door. The tab end 42, by engaging lower leg 22, creates a tension winding effect (torsion) along the spiral length of the coil 40, and which maintains a failsafe door closing motion in the event of a cam failure. Concurrently, the action of surface 47 through the cam surfaces 50 and 52 results in coil 40 expanding to automatically pivot the door to its fullest opened and closed positions.

A collar, see as generally referenced at 48, is secured to a location of the intermediate extending bracket 20 and proximate the upper or second extending leg 24. As best illustrated by the underside perspective view of FIG. 5, the collar 48 is provided as a substantially three-dimensional cylindrical shaped element and exhibits, on its lower facing surface, a cam profile which is in abutting contact with the upper arcuate extending surface 47 of the coil spring member.

The cam surface profile further defines a first circumferentially extending and tapered location 50, and which corresponds to a first door closed (or closing influenced) position. A succeeding second and circumferentially extending cam lobe location 52 (see again FIG. 5) corresponds with a second door open position.

As is further best referenced by FIG. 5, the collar 48 includes a central aperture 54 for slidingly receiving the arcuate bracket portion and such that the cam profile (circumferential surfaces 50 and 52) is in opposing and abutting fashion with the upper arcuate surface 47 of the main coil spring 40. The collar 48 is further fixedly secured to the bracket portion by a slot recess 56 defined in a top edge surface and which seats the angled upper leg 24 (see also FIG. 1) of the bracket portion. This configuration, combined with the compressing forces applied by the coil spring 40, prevents the collar 48 from rotating relative the bracket portion and during successive winding and unwinding of the coil spring member in the manner to now be described.

Referring to FIG. 2, an overhead plan view is illustrated of the door jig assembly 10, illustrated in both a closed position of the door 14 in solid (see also side cutaway of FIG. 3) as well as a succeeding open position, in phantom at 10′ and illustrating the door at further and substantially 90° rotated open position 14′. The phantom illustration 44′ of the coil spring stem portion in FIG. 2 further shows the arcuate cantilevering and biasing nature of the extending stem portion extending through the door aperture 46. The phantom illustration 44′ of the stem portion further corresponds to the winding rotation of the arcuate abutting surface 46 of the main coil spring 40, relative the cam profile of the collar 48, and such that the surface 47 rotates and seats within the lobe profile 52 (see also side cutaway of FIG. 4).

As is illustrated, the initial travel of the coil spring, in a range across the tapered location 50, coincides with the door 12 being influenced in closing direction. In a preferred embodiment, a maximum door closing influence ranges up to a 30° range from an absolute door closed position. This influence corresponds to the desire to maintain the door 12 closed in response to inadvertent contact and collision forces applied to the vehicle frame as it is translated along a vehicle assembly line. At opening degree angles, beyond 30°, the responsive closing forces exerted upon the door 12 decreases up to the point (usually after a 60°-75° opening angle) at which point the arcuate coil spring surface 47 seats within the cam lobe 52 region of the collar and the closing door influence is substituted by an opening door influence.

It is also envisioned that the upper leg 24 of the arcuate bracket portion can be reconfigured such that it can substitute, and thereby replace, the functions provided for by the cam surfaces 50 and 52. In particular, the upper leg would define a combined coiled/spiraled configuration further incorporating a cam profile (such as again evidenced by 50 and 52).

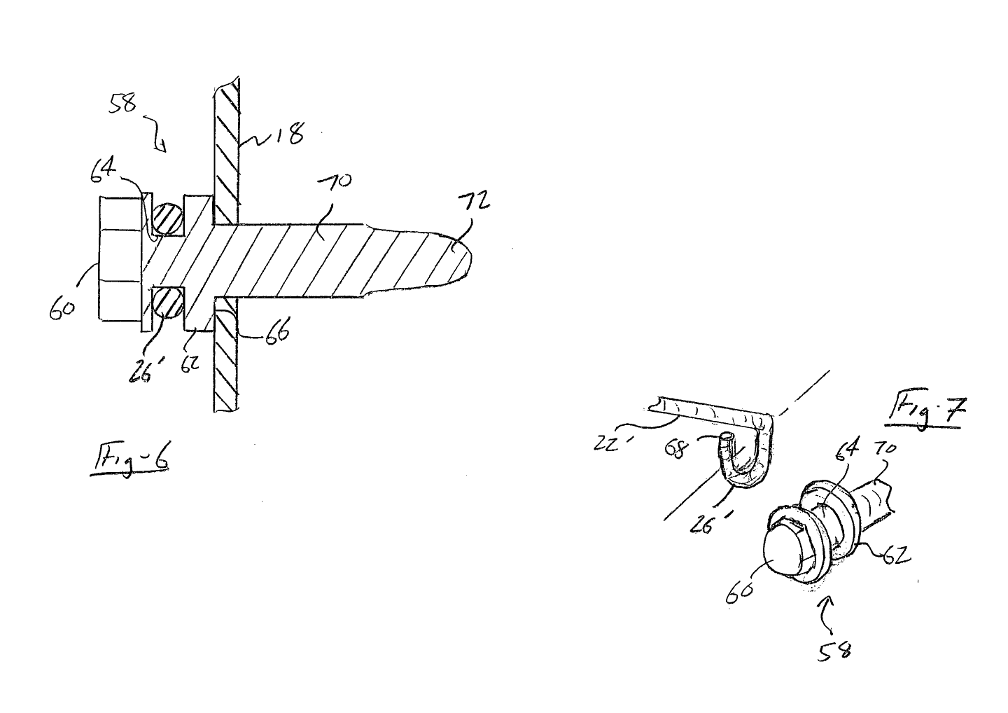

Referring finally to FIGS. 5 and 6, side cutaway and exploded perspective illustrations are presented of an alternately configured bolt 58 according to the present invention. The bolt 58 according to this further preferred embodiment incorporates a conventional (typically hexagonal) head 60 with an integrally configured and spaced apart collar 62. An annular recessed surface 64 established between the hex head 60 and the collar 62 defines a seating location for receiving a modified substantially “U” shaped and perpendicular extending portion 26′ associated with a lower extending leg 22′ of the arcuate bracket.

The objective of the bolt 58 with collar 62 is to space, or shim, the modified “U” shaped bracket portion 26′ away from the surface 18 of the inner door jamb, and to thereby allow substantial access to door jamb surface 18 (exclusive of the area abutted by inner face 66 of the collar 62) to allow for application of painting (top coat or undercoat) and to thereby help to prevent against corrosion and the like. As is best shown in FIG. 7, the terminating end of the “U” shaped portion is substantially shorter than that associated with the variant of FIG. 1, as seen at 68, and which is made possible by the provision of the bolt 58 with spacer collar 62.

It is also envisioned that a subset number of the bolt heads 60 can be painted a specified color (e.g. red) and in order to designate a right side application, and as opposed to a corresponding left side application and by which the bolt head can remain unpainted. Furthermore, an extending shaft 70 of the bolt 58 terminates in a rounded pilot nose 72, the purpose for which is to facilitate alignment of the bracket assembly in a corrected fashion, upon insertion, and to compensate for variations in vehicle make or model.

Having described my invention, additional preferred embodiments will become apparent to those skilled in the art to which it pertains and without deviating from the scope of the appended claims.

I claim:

1. A door jig assembly for use with a vehicle, the vehicle including a door having an inner facing edge, through which is defined at least one aperture, and opposing an inner door jamb forming a part of a vehicle door frame, the door further capable of being pivoted about hinges secured to the door frame and between opened and closed positions, said jig assembly comprising:
an arcuate bracket portion fixedly secured to the inner door jamb;
a coil spring member surrounding an intermediate extending location of said bracket portion, a first tab end of said coil spring biasingly engaging a location along said bracket portion, a second end of said coil spring defining an elongate extending stem portion passing through the aperture defined in the vehicle door; and
a collar secured to a further location of said bracket portion and exhibiting a cam surface in abutting contact with an arcuate extending surface of said coil spring member;
said coil spring member influencing the door to remain in a first closed position, rotation of the door to a second open position causing said coil spring to rotate about said cam surface of said collar and to influence said door in an opposite and door open position.

2. The door jig assembly as described in claim 1, said arcuate bracket portion further comprising first and second legs extending from opposite ends of said intermediate bracket portion, said legs engaging first and second locations associated with the inner door jamb.

3. The door jig assembly as described in claim 2, said first leg further comprising a lower leg terminating in a substantially “U” shaped and perpendicularly extending portion, said “U” shaped portion aligning with an aperture in the door jamb and through which is engaged a mounting bolt for securing said first leg thereto.

4. The door jig assembly as described in claim 3, said bolt further comprising an axially spaced collar and defining an annular recess therebetween for seating said “U” shaped bracket portion and for spacing said bracket portion from the inner door jamb.

5. The door jig assembly as described in claim 3, said second leg further comprising an upper leg extending through a further spaced apart aperture defined in the door jamb.

6. The door jig assembly as described in claim 5, said collar securing to an upper end of said intermediate extending location of said bracket portion and being rotatably restrained by said upper extending leg.

7. The door jig assembly as described in claim 1, said cam surface associated with said collar further comprising a first circumferentially extending and tapered location corresponding with said first closed position, a succeeding second and cam lobe location corresponding with said second open position.

8. The door jig assembly as described in claim 7, said closing and opening influence positions corresponding to a substantially 90° rotation of the door relative to the inner doorjamb.

9. The door jig assembly as described in claim 1, further comprising said coil spring extending stem portion biasing against an inside surface of the vehicle door and exhibiting a cantilever load in said first and second positions.

10. The door jig assembly as described in claim 1, said coil spring member exhibiting a specified shape and size and being constructed from a spring steel material.

11. The door jig assembly as described in claim 1, further comprising a sleeve inserted between said intermediate extending location of said bracket and said coil spring, said sleeve maintaining axial alignment between said sleeve and said coil spring during rotation of the door.

12. A door jig assembly for use with a vehicle, the vehicle including a door having an inner facing edge, through which is defined at least one aperture, and opposing an inner door jamb forming a part of a vehicle door frame, the door further capable of being pivoted about hinges secured to the door frame and between opened and closed positions, said jig assembly comprising:
an arcuate bracket portion fixedly secured to the inner door jamb, said arcuate bracket portion further comprising first and second legs extending from an intermediate extending location thereof;
a coil spring member surrounding said intermediate extending location of said bracket portion, a first tab end of said coil spring biasingly engaging a location along said bracket portion, a second end of said coil spring defining an elongate extending stem portion passing through the aperture defined in the vehicle door; and
a collar secured to a further location of said bracket portion and exhibiting a cam surface in abutting contact with an arcuate extending surface of said coil spring member, said cam surface further defining a first circumferentially extending and tapered location corresponding with a first door closed position, a succeeding second and cam lobe location corresponding with a second door open position;
said coil spring member seating within the extending and tapered location to influence the door to remain in said first closed position, rotation of the door to a second open position causing said arcuate extending surface of said coil spring to rotate about said cam surface of said collar, into said cam lobe location, to thereby influence said door in an opposite and door open position.

13. A door jig assembly for use with a vehicle, the vehicle including a door having an inner facing edge, through which is defined at least one aperture, and opposing an inner door jamb forming a part of a vehicle door frame, the door further capable of being pivoted about hinges secured to the door frame and between opened and closed positions, said jig assembly comprising:
an arcuate bracket portion fixedly secured to the inner door jamb;
a coil spring member surrounding an intermediate extending location of said bracket portion, a first tab end of said coil spring biasingly engaging a location along said bracket portion, a second end of said coil spring defining an elongate extending stem portion passing through the aperture defined in the vehicle door; and
a cam surface established between an arcuate extending surface of said coil spring member and an abutting surface associated with said bracket portion;
said coil spring member influencing the door to remain in a first closed position, rotation of the door to a second open position causing said coil spring to rotate about said cam surface of said collar and to influence said door in an opposite and door open position.
